(19) United States
(12) Patent Application Publication
(10) Pub. No.: US 2018/0322560 A1
(43) Pub. Date: Nov. 8, 2018

(54) SYSTEM FOR GENERATING AND TRANSMITTING INDICATIONS OF INTEREST

(71) Applicant: FIDESSA PLC, London (GB)

(72) Inventors: Christopher Kelley, Brooklyn, NY (US); Jed Harris Blumenfeld, Pelham, NY (US)

(73) Assignee: FIDESSA PLC, London (GB)

(21) Appl. No.: 15/585,367

(22) Filed: May 3, 2017

(51) Int. Cl. G06Q 30/06; H04L 29/08; G06Q 30/02

(52) U.S. Cl. CPC G06Q 30/0631; G06Q 30/0283; H04L 67/32

(57) ABSTRACT

A system for distributing indications of interest (IOIs) to trade one or more financial instruments is provided, where the system includes at least an input/output (I/O) device, an order management system, a data server, and an analysis and correlation engine communicatively coupled to the I/O device, the order management system, and the data server. The analysis and correlation engine can be configured to receive merchandise-related data from the I/O device, trade order data from the order management system, and client holdings data from the data server. The system can be configured to calculate correlation data based on the merchandise-related data, the trade order data, and the client holdings data and to select one or more target clients for receiving IOIs based on the correlation data. The system can also create and transmit IOI messages to the one or more target clients.

### BACKGROUND

Conceptually, an indication of interest (MI) is an expression of trading interest for a financial instrument. In markets that support the trading of securities, IOIs can be implemented in an electronic format that includes, for example, a security name or ticker, whether the participant expressing interest is a buyer or a seller, the number of shares the participant is interested in, and/or a target price for the purchase or sale. Financial institutions, such as broker/dealers, can electronically communicate or advertise proprietary or client trading interest in the form of IOIs to buy-side or other sell side market participants, such as mutual funds or hedge funds, either using their own systems or through third party trading platforms.

In many cases, a trader that is employed by a financial institution to manage the institution's customer orders or to engage in proprietary trading for the firm will use IOIs as one of a number of strategies for executing a given order. IOIs are used to attract other customers of the firm who may wish to trade the other side of an order (e.g., if the existing customer has placed an order to buy the security, IOIs are used to attract other customers who may wish to sell that same security). Typically, these traders do not directly manage client relationships, and therefore lack knowledge of which of the institutions' customers would be particularly interested in trading the other side of that order. As a consequence, it is common for the trader to send out IOIs to all (or most) of the institution's clients, often using a static distribution list of clients that is not derived based on each client's anticipated interest in that particular security. The trader typically performs this task (rather than a sales trader) because the trader is best positioned to determine when and whether to use IOIs on behalf of the trader's order, and what attributes (notably share quantity and price) to use for the IOI. However, this is not optimal in that the institution's sales traders, in the aggregate, will have a better understanding of which of the institution's customers are most likely to respond favorably to the IOI. This is not a deliberate choice, but rather the result of limitations of present technologies and workflows.

The institution's clients will each typically receive a significant volume of IOIs, both from this institution and others with which the client does business. Thus, current techniques for communicating IOIs to clients can overwhelm the clients with large volumes of potentially irrelevant information. Receiving and analyzing this information is costly to clients and is potentially harmful to the relationship between the institution and its clients; it may also result in the institution's IOIs being disregarded by a particular client. However, targeting IOIs to specific clients that are likely to have an interest in the trading opportunity would require the institution to analyze each IOI with respect to each client's likely trading interest. This process is both complex and prohibitively labor-intensive, in that the institution would need to analyze a significant amount of data from a variety of sources to gauge each client's likely interest in a given IOI. This would be a time consuming task for traders, and would divert traders' attention from other areas requiring their focus and attention.

Thus, a need has arisen to create a system that generates and distributes IOIs based on customer and/or proprietary trading interest, and is capable of automatically routing those IOIs to the most appropriate clients, i.e., those clients that are most likely to be interested in trading the securities underlying the IOIs. A subsidiary need for such a system is a means for allowing for some IOIs to be “held” by the system so that, prior to being forwarded to a client, a user of the system can analyze the IOI and target it to specific clients based on the trader's personal knowledge, which may not be entirely accounted for by the information stored within the electronic trading platform.

### SUMMARY

The presently disclosed subject matter provides systems and techniques for generating IOIs based on customer orders and/or proprietary trading interest, and then releasing the IOIs in a targeted fashion to a financial institution's clientele.

In one aspect of the disclosed subject matter, a method for generating and distributing indications of interest (IOIs) to clients is provided. The method can include receiving an order, posting a portion of the order to a merchandise board as a merchandise item, generating a plurality of IOI shapes corresponding to the merchandise item, and mapping one or more clients to one or more tiers associated with each shape. The method can also include generating a client score for each of the one or more clients, the scoring based on at least one of client financial data, client holdings, and historic client orders. The method can also include displaying on a display clients and IOIs, associating clients into one or more tiers with a corresponding IOI shape, generating an IOI message for each IOI shape, and transmitting each shape to the clients associated with each tier.

In another embodiment, a computer system for generating and distributing indications of interest (IOIs) to clients is disclosed. The computer system includes one or more processors and a memory. The memory stores instructions that, when executed by the one or more processors, cause the computer system to carry out the method disclosed above.

In another embodiment, a non-transitory computer-readable medium storing instructions that, when executed by a processor, cause a computer system to generate and distribute indications or interest (IOIs) to clients is disclosed. The non-transitory computer-readable medium performs the operations to carry out the method disclosed above.

### BRIEF DESCRIPTION OF THE DRAWINGS

FIG. 1 is a block diagram of a system for transmitting IOIs to one or more clients in accordance with one or more embodiments.

FIG. 2 is a schematic flow diagram depicting a method for generating and distributing indications of interest (IOIs) to clients in accordance with one or more embodiments.

FIG. 3 is a diagram of a graphical user interface for enabling a sales trader or end user to opt-in or opt-out a client from receiving IOIs, in accordance with one or more embodiments.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

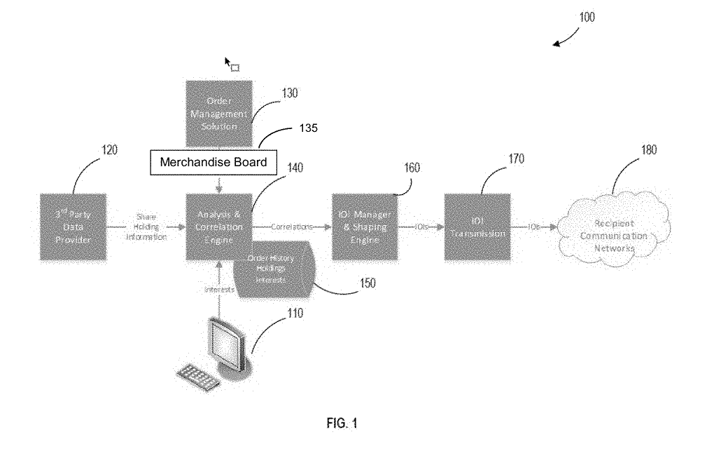

FIG. 1 depicts an exemplary system 100 configured to generate IOIs based on merchandise residing on one or more order management platforms, and to distribute those IOIs to one or more clients in a targeted manner. The components depicted in FIG. 1 can be implemented on one or more computing devices, including, but not limited to, mainframes, mid-range computers, server-grade workstations, desktop computers, and portable computing devices such as laptop computers. These computing devices can be connected to one another, for example, in a local area network (LAN), a wide area network (WAN), or a cloud-based computing environment. Further, several or all of the depicted components are capable of being run on a single computing device.

Referring to FIG. 1, system 100 includes an input/output (I/O) device 110. According to the depicted embodiment, I/O device 110 provides for the entry of interests in particular merchandise, for example, merchandise that a specific client maintains an interest in. The merchandise can include, for example, one or more of a security identifier (such as a ticker symbol), an indication of whether the securities are being offered for sale or solicited for purchase, a number of securities proposed to be traded, and a target buying or selling price for the security. Once entered into system 100, the merchandise is stored, for example, on a data storage device (such as data storage 150).

System 100 also includes data provider 120, which stores and provides data pertaining to clients' holdings of one or more securities. For example, in some embodiments, data provider 120 comprises clients' current and historical holdings for one or more securities, as well as clients' historical order data. As shown below, this data enables system 100 to determine correlations between clients' trading patterns and generate IOIs in order to target the IOIs to clients who are more likely to be interested in them.

As shown in FIG. 1, system 100 also includes an order management system 130, which provides real time order data to system 100. The order data pertains to current client orders and/or proprietary trading interest for one or more securities. Included as part of order management server 130 is a merchandise board 135, which provides an internal display (i.e., a display only viewable to the users of system 100) of real time order related data.

The use of the merchandise board 135 to display live trading interests internally allows for the matching of interests with opposing trading interests from one or more of the institution's clients. Such internalization is oftentimes preferable to trading an order in the market as the internalization can offer a reduction in the market impact and/or a price improvement. As such, a trader can post a client order to the merchandise board 135 upon receipt, or can wait until a later time. Rules-based logic can also automatically post specific client orders to the merchandise board 135. The trader, or a rule, can choose to represent only a subset of the total order quantity on the merchandise board 135 and/or represent a different price. As a result, the presentation on the merchandise board 135 need not exactly represent the attributes of the related order. In certain embodiments, the merchandise board 135 can aggregate the representations of multiple orders for the same security and direction.

I/O device 110, data provider 120, and order management system 130 each feed into analysis and correlation engine 140 via communicative coupling. Analysis and correlation engine 140 stores the information fed to it on data storage 150 and uses this information to determine the existence of correlations between the IOIs entered into system 100 and client trading patterns that engine 140 determines based on information received from data provider 120 and order management system 130. Specifically, engine 140 leverages client trading activity, shareholdings data, and explicitly communicated interest lists to determine a client's potential interest in trading a specific instrument. This information highlights which clients are candidates to receive an IOI. In some embodiments, analysis and correlation engine 140 then provides correlation data to IOI manager and shaping engine 160.

IOI manager and shaping engine 160 stores IOI generation, eligibility, and shape criteria, and uses the received correlations to determine which clients should receive IOIs automatically. A master IOI that is generated by IOI manager and shaping engine 160 has one or more shapes, where each shape corresponds to, for example, a price, quantity, and release time. Customers are assigned to one of the shapes based on the tier the client is in. For example, a buy-side client can have a default tier for most stocks, but can be in a different tier for one or more specific instruments. Engine 160 further determines when those IOIs are to be transmitted, and whether certain IOIs should be shaped (i.e., customized) before being transmitted. To customize IOIs, engine 160 can also include a user interface (not shown) to enable an end user to modify the IOI by, for example, including or excluding one or more customers from receiving the IOI.

Different representations of a given merchandise item can be sent to different clients. As such, different IOI shapes can be produced from a single merchandise item. Each IOI shape can be distributed to a different tier of client. Rules based logic can determine the attributes of each IOI shape. Each shape can vary from the others by a number of attributes, as discussed supra. By way of example only, and not intended to be limiting, a first merchandise item exists to buy 100,000 shares of stock 1 at $800.00 per share. The tier 1 shape can match the attributes of the merchandise item (i.e., 100,000 shares at $800.00 per share). A rule can dictate that the tier 2 shape for this merchandise item is 90% of the share quantity, with a ten cent price offset and a ten minute release time offset (each relative to the tier 1 shape). Thus, the tier 2 shape is buy 90,000 shares of stock 1 at $799.90 per share. The initial IOI for the tier 2 shape will be sent ten minutes later than the initial IOI for the tier 1 shape. By way of continued example, the tier 3 shape is 75% of quantity, with a 15-cent price offset and a 25 minute release time offset (each relative to the tier 1 shape). Thus, the tier 3 shape is buy 75,000 shares of stock 1 at $799.85. The initial MI for the tier 3 shape will be sent 25 minutes later than the initial IOI for the tier 1 shape and 15 minutes later than the initial IOI for the tier 2 shape. Tier 4 shapes etc. can be derived in a similar manner. This rules-based logic will commonly be defined uniformly for all securities, although the logic can be overridden with shaping rules that apply to specific securities or groups of securities.

As shown in FIG. 1, IOI manager and shaping engine 160 sends IOI related data to IOI transmission module 170. IOI transmission module 170 converts the IOI related data into an appropriate format, if necessary, such as industry-standard IOI messages and, using stored IOI service destination information, distributes the IOIs to intended recipient clients. As shown, the recipient clients connect to recipient communication network 180.

Furthermore, in some embodiments, while the IOI shapes are defined for a given merchandise item, a score is also tabulated for each client with respect to that specific merchandise item. In certain embodiments, the score may be calculated at the same time the IOI shape is being defined. A client score for a given merchandise item can represent the expected likelihood that the customer is interested in trading the other side of that merchandise item. By way of example only and not intended to be limiting, a client score for a merchandise item that is a buy of stock 1 represents the expected likelihood that the client is interested in selling stock 1. Scores can be computed by considering various data sources to determine the overall expected likelihood that a client is interested in trading the other side of the particular merchandise item. These data sources include, by way of example only, the client's history of orders in this security, the client's history of orders in related securities, the client's holdings in this security (which can typically be derived from public regulatory filings, such as those required by the SEC in the United States), and/or the client's previously-communicated interest in trading the security (which can typically be derived from interests expressed by the client and recorded by the sales trader).

Furthermore, in some embodiments, a sub-score is also calculated for each individual data source (for example, a “historic orders” sub-score, a “holdings” sub-score, etc.). Each sub-score is calculated via a formula that is appropriate to the particular data source, but using a congruent numeric scale. By way of example only, a “historic orders” sub-score of 7 and a “holdings” sub-score of 7 represent the same expected level of client interest. In some embodiments, the overall score can be derived by selecting the highest of the sub-scores. In some embodiments, a sell score and a buy score can also each be calculated for each client in each security for each day. It is further contemplated that scores and/or sub-scores can be determined and/or calculated on demand, in real time. This approach can be utilized if the data sources driving the one or more sub-scores did not update each day or if the scores and/or sub-scores needed to take into account the specific attributes of the current merchandise item rather than reflect the scored client's likelihood of wanting or buy or sell the particular security.

Furthermore, in some embodiments, rules-based logic can determine whether each client should be automatically opted-in to receive an IOI representing the merchandise item. The rules-based logic can be based on the numeric score for the particular client and the merchandise item, among other factors. Individual clients can have different minimum scores for the automatic opt-in. By way of example only, client A can be automatically opted-in for scores of seven or higher, while client B can be opted-in for scores of five or higher. In some embodiments, the trader who is posting the merchandise item can also stipulate the minimum score a client must have to receive the IOI.

The auto-IOI logic can also offer smart-blocking. When utilized, smart-blocking can ensure that a particular client will not be automatically opted into an IOI for a merchandise item that is based on the particular client's own order. In some embodiments, smart-blocking can also prevent the client from being opted into IOIs in any securities in which the customer has an active order, even if the merchandise board item does not represent the particular client's order. In other embodiments, smart-blocking can also prevent the client from being opted into IOIs in any securities in which the customer has an active order, even if the merchandise board 135 is in the opposite buy/sell direction as the client order. The auto-IOI logic can also support client blacklists. A client blacklist can specify a set of securities for which that client does not wish to receive IOIs.

Importantly, the auto-IOI logic can opt clients into receiving IOIs based on certain merchandise items; however the IOIs do not necessarily need to be immediately transmitted to the clients. In some embodiments, transmission can take place after an interval of time has elapsed. Prior to this point, users can override the auto-IOI logic as set out infra.

### Example 1

By way of example only, and not intended to be limiting, the main IOI user interface object can be a grid-based display used primarily by sales traders (“MI board”). The IOI board can include a row for each merchandise item, and a column for each client. All users can see the same set of rows but each user can see columns only for clients managed by that particular sales trader (whether exclusively or in collaboration with other sales traders). Each cell in the grid can represent the intersection of one client and one merchandise item. In an initial state for a given merchandise item (i.e., after all scores and auto-IOI rules have been calculated and applied, but before the user has interacted manually with it) the IOI board can indicate, among other things: whether the client has a non-zero score for the particular merchandise item; whether the client is currently opted-in to receive an IOI for the particular merchandise item; and/or whether the client has already been sent at least one IOI message relating to the particular merchandise item. In certain embodiments, a non-zero score for a particular merchandise item can be represented by a colored ring, wherein specific colors indicate particular score ranges. Furthermore, the IOI board can use specific symbols to indicate instances where a merchandise item reflects the customers' own order, and another symbol to indicate where the relevant security is on the particular client's blacklist.

In certain embodiments, a user can interact with the IOI board to refine the choices made by the auto-IOI logic. In particular, a user can select a non-zero score denoting a current state of opted-in in order to change the status from opted-in to opted-out. The user can select a non-zero score denoting a current state of opted-out to change the status from opted-out to opted-in. Furthermore, the user can select a score of zero denoting a current state of opted-out in order to opt-in that particular client to receive an IOI for the merchandise item, even though that client has a score of zero for that merchandise item. Also, in some embodiments, user can interact with the IOI board continuously, opting-in and opting-out as desired over time.

After a merchandise item has been posted and scored, each customer that is opted-in to receiving an IOI for a given merchandise item is associated with one of the five IOI shapes associated with the particular merchandise item. Typically, the association with an IOI shape is based on the placement of the client into a particular client tier. By way of example only, a tier 1 client will receive the tier 1 IOI shape, a tier 4 client will receive the tier 4 IOI shape, etc. This association can typically be based on a tier designation for the client across all securities. However, it is also contemplated that a client may be assigned to a different tier for a particular security or group of securities. All customers who receive the same IOI share are deemed to be recipients of the same notional IOI. A separate release time is calculated for each of the following IOI shapes as follows: the release time for the tier 1 IOI shape is calculated by adding the initial timer value (denoted in seconds) to the current time; and the release time for the remaining tiers of IOI shapes is calculated by adding the release time offset for that particular shape to the tier 1 IOI shape release time. Once the release time for a given IOI shape is reached, the IOI is transmitted to all opted-in recipients of that particular shape. Until that time, users of the IOI board have the opportunity to opt-out any client from receiving any IOI before the client receives the first IOI message.

Once the initial IOI message for a given IOI shape has been sent, the IOI message continues to re-roll at intervals. This is intended to ensure that the IOI is periodically re-displayed to recipients. Re-rolling typically follows fixed time schedules (i.e., re-roll every 20 minutes); however less predictable may be desired in some cases (for example, randomized). It is also contemplated that different re-roll intervals can be applied to different securities or groups of securities, and/or to different tiers. Benefits of the present disclosure includes that sales traders can continuously monitor their IOI dash display for new merchandise items and/or be alerted to new merchandise items. Furthermore, sales traders can opt clients into and out of individual IOIs over the course of the day. When a previously opted-in client is opted-out, the client will not receive subsequent re-roll messages for that particular IOI. When a client is opted-in to an IOI shape whose initial message has already been sent, the client will receive all subsequent reroll messages for that IOI. There can also be an automatic or manual function that allows that opted-in client to receive an initial IOI message immediately (sent only to that client), and then receive all subsequent messages along with other clients receiving that particular IOI shape. As such, the user is provided with the option to transmit an instance of that IOI to the particular client immediately, while still allowing the particular client to subsequently join other recipients of the IOI shape according to a single reroll schedule for the IOI shape.

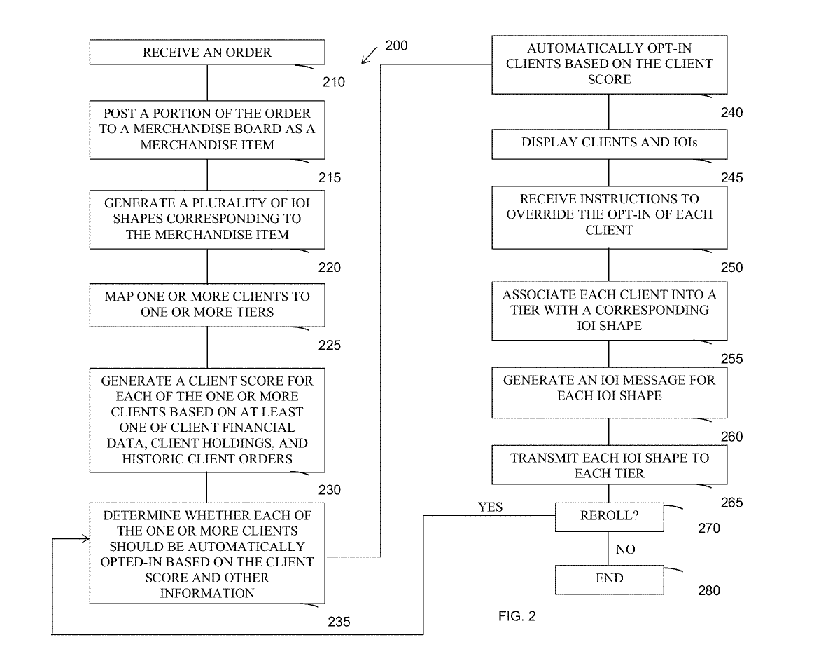

FIG. 2 is a flow diagram that depicts a method 200 for generating and distributing IOIs to clients, according to one or more embodiments. Method 200 can be executed by an electronic trading platform at a financial institution. Method 200 begins at operation 210, where an order is received. At operation 215, a portion of the order is posted to a merchandise board as a merchandise item. In some embodiments, the posting can occur in real time. As previously mentioned, order management system 130 can provide for such a merchandise board 135, which allows users of system 100 to view merchandise that corresponds to either received orders or to proprietary trading interest in one or more securities.

Next, at operation 220 a plurality of IOI shapes are generated. Each IOI shape can correspond to the merchandise item. In some embodiments, each IOI shape corresponds to at least one of a price, a quantity, and/or a release time. At operation 225, one or more clients are mapped to one or more tiers. At operation 230, a client score is generated for each of the one or more clients. The client score can be based on at least one of client financial data, client holdings, and/or historic client orders. In some embodiments, client financial data includes one or more of client trading activity, predetermined client preferences, currently held securities by the client, client exposure to various market sectors, client related new, and/or client competitor related news. In certain embodiments, the score is tabulated for each client with respect to a specific merchandise item. As discussed above with reference to FIG. 1, a client score for a particular merchandise item represents the expected likelihood that the customer is interested in trading the other side of the merchandise item. At operation 235, a determination is made whether each of the one or more clients should be automatically opted-in based on the client score and other information. At operation 240, clients are automatically opted-in based on the client score. As discussed above with reference to FIG. 1, rules-based logic determines whether each client should be automatically opted-in to receive and IOI representing the merchandise item. This logic can be based on the numeric score for a particular client and merchandise item, but other factors can also be operative. Also, in certain embodiments, the auto-IOI logic can opt a client into receiving IOIs based on certain merchandise items, however it does not immediately transmit those IOIs to the client, as transmission can take place after an interval of set time has elapsed. In some embodiments, prior to this point, a user can override the auto-IOI logic.

At operation 245, clients and IOIs are displayed. In some embodiments, the clients and/or the IOIs can be displayed on an interface, disclosed infra. At operation 250, instructions can be received to override the opt-in of each client, as disclosed above with reference to FIG. 1. At operation 255, each client is associated into one or more tiers with a corresponding IOI shape, as discussed above. The association into one or more tiers can be based on a tier designation for each client across all securities. However, it is contemplated that a client can be assigned to a different tier for a particular security or group of securities. At operation 260, an IOI message is generated for each IOI shape. At operation 265, each shape is transmitted to each tier. All clients who receive the same IOI shape are recipients of the same notional IOI. A separate release time can be calculated for each of the following IOI shapes as discussed above with reference to FIG. 1. Once the release time for a given IOI shape is reached, the IOI is transmitted to all opted-in recipients of that particular shape.

Furthermore, at operation 270 a determination is made regarding a reroll. If a reroll is necessary (i.e., YES at operation 270), the method returns to operation 235. If a reroll is not necessary (i.e., NO at operation 270), the method ends at operation 280. As disclosed above, one the initial IOI message for a given IOI shape has been sent, that IOI continues to reroll at intervals. As such, the IOI is periodically re-displayed to recipients. In some embodiments, rerolling can follow a fixed time schedule, while in other embodiments, rerolling can follow a randomized schedule. Sales traders can monitor each IOI dash display for new merchandise items, and sales traders can also opt client into and out of individual IOIs over the course of time. As disclosed above with reference to FIG. 1, when a previously opted-in client is opted out, the client will not receive subsequent reroll messages for that particular IOI. When a client is opted in to an IOI shape whose initial message has already been sent, the client can receive all subsequent reroll messages for that IOI. In some embodiments, an opted in client can automatically or manually receive an initial IOI message immediately which was only sent to that client, and then receive all subsequent messages along with other clients receiving that particular IOI shape. As such, the user can transmit an instance of the IOI to a particular client immediately, while still allowing the client to subsequently join other recipients of that IOI shape according to a single reroll schedule for the corresponding IOI shape.

In some embodiments, the method 200 can also include determining a time value for transmission of the IOI messages.

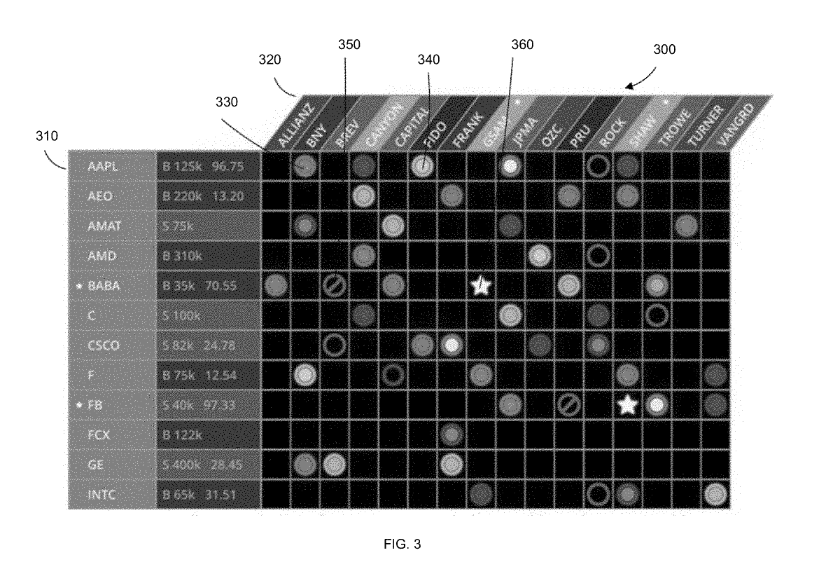

FIG. 3 is a diagram of a graphical user interface 300 for enabling a sales trader or end user to opt-in or opt-out a client from receiving IOIs. As such, the graphical user interface 300 identifies whether a client has been opted-in or opted-out of the receipt of an IOI for a particular merchandise item. Also, the sales trader can manually opt-in or opt-out the client from an IOI via the graphical user interface 300. Furthermore, in some embodiments, the graphical user interface 300 can identify correlations between real time orders and client trading preferences. User interface 300 can serve as a trader “dashboard,” which can assist traders in identifying those clients to which IOIs have been transmitted, as well as clients to that are potential targets of IOIs. It should be noted that interface 300 is one example of a trader dashboard; many variations and arrangements are possible and within the scope of the present disclosure. Indeed, the present disclosure contemplates any interface that displays and identifies: each correlation that exists for every client/trade order combination; the score of that correlation; if an IOI was automatically generated; if an IOI was manually generated; the shape of the IOI generated; and/or if the client was opted in or out from receiving an IOI based on the correlation. In addition, such interfaces can identify which instruments clients have disabled receiving IOIs about and which instruments each of the clients currently owns.

As shown in FIG. 3, interface 300 comprises a grid of columns and rows. Each row represents a merchandise item that reflects a real time order received by system 100 via order management system 130 or, alternatively, a proprietary trading interest. For example, as shown by row 310, a merchandise item that reflects a complete order to buy 125,000 shares of Apple (ticker symbol AAPL), or a portion of a larger order to buy Apple shares, 125,000 of which was posted on the merchandise board, at a price of $96.75 has been received by system 100.

The columns of interface 300 correspond to individual clients of the financial institution. In some cases, one column is displayed for each of the institution's clients. In other embodiments, the displayed columns correspond only to the clients that are being handled by a particular end user (i.e., a trader). For example, as shown in FIG. 3, column 320 corresponds to Allianz, a client of the financial institution.

At the intersection of each row and column is a cell that contains information on whether, for the particular financial instrument corresponding to the row, the corresponding client: has received an IOI; has opted out of receiving IOIs for the particular financial instrument; has not received an IOI, but, based on its trading preferences, is likely to respond favorably to an IOI; and/or has not received an IOI, but, based on its trading preference, is likely to respond unfavorably to receiving an IOI. Further, a cell can indicate that a client already owns the financial instrument corresponding to the row.

For example, cell 330 indicates that client Bank of New York (abbreviated BNY), based on its trading preferences, has a high likelihood of responding favorably to an IOI to trade the 125,000 shares of Apple stock at $96.75. On the other hand, cell 340 indicates that Fido Asset Management (abbreviated FIDO) will most likely have a moderate interest in such an IOI to trade the Apple shares.

Furthermore, as shown by cell 350, Brevan Howard Asset Management (abbreviated BREV) does not trade at all in Alibaba Group (ticker symbol BABA) shares. In addition, as shown by cell 360, Goldman Sachs Asset Management (abbreviated GSAM) currently has an active order in BABA with BREV. This typically means GSAM's order represents a part of (or all of) a merchandise item for BABA.

As an example of the operation of system 100, assume a client order to buy 500,000 shares of Microsoft stock (MSFT) is received by a sales trader. The sales trader then splits 250,000 shares of the order to a trader to work with. The trader elects to publish all 250,000 shares of the order to buy MSFT to the merchandise board. The analysis and correlation engine then uses real time and historical data to determine if any correlations exist for the 250,000 share merchandise item to buy MSFT that is on the merchandise board. Based on the correlations that are identified, the IOI manager and shaping engine determines, based on the tier each client is in, which clients should automatically receive an IOI for the merchandise and how that IOI will look. The IOI transmission module then facilitates delivery of the IOIs.

The disclosed subject matter can also allow traders to add value by ensuring clients only receive IOIs when they have a potential interest in trading a financial instrument, thereby increasing the value of each IOI sent to the client while decreasing the number of IOIs for the client to review.

Although one or more embodiments have been described herein in some detail for clarity of understanding, it should be recognized that certain changes and modifications can be made without departing from the spirit of the disclosure. The embodiments described herein can employ various computer-implemented operations involving data stored in computer systems. For example, these operations can require physical manipulation of physical quantities—usually, though not necessarily, these quantities can take the form of electrical or magnetic signals, where they or representations of them are capable of being stored, transferred, combined, compared, or otherwise manipulated. Further, such manipulations are often referred to in terms, such as producing, yielding, identifying, determining, or comparing. Any operations described herein that form part of one or more embodiments of the disclosure can be useful machine operations. In addition, one or more embodiments of the disclosure also relate to a device or an apparatus for performing these operations. The apparatus can be specially constructed for specific required purposes, or it can be a general purpose computer selectively activated or configured by a computer program stored in the computer. In particular, various general purpose machines can be used with computer programs written in accordance with the teachings herein, or it can be more convenient to construct a more specialized apparatus to perform the required operations.

The embodiments described herein can be practiced with other computer system configurations including hand-held devices, microprocessor systems, microprocessor-based or programmable consumer electronics, minicomputers, mainframe computers, and the like.

One or more embodiments of the present disclosure can be implemented as one or more computer programs or as one or more computer program modules embodied in one or more computer readable media. The term computer readable medium refers to any data storage device that can store data which can thereafter be input to a computer system—computer readable media can be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Disc), a CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications can be made within the scope of the claims. Accordingly, the described embodiments are to be considered as illustrative and not restrictive, and the scope of the claims is not to be limited to details given herein, but can be modified within the scope and equivalents of the claims. In the claims, elements do not imply any particular order of operation, unless explicitly stated in the claims.

Many variations, modifications, additions, and improvements can be made. Plural instances can be provided for components, operations or structures described herein as a single instance. Boundaries between various components, operations and data stores are somewhat arbitrary, and particular operations are illustrated in the context of specific illustrative configurations. Other allocations of functionality are envisioned and can fall within the scope of the disclosure(s). In general, structures and functionality presented as separate components in exemplary configurations can be implemented as a combined structure or component. Similarly, structures and functionality presented as a single component can be implemented as separate components. These and other variations, modifications, additions, and improvements can fall within the scope of the appended claim(s).

What is claimed is:

1. A computer system for generating and distributing indications of interest (IOIs) to clients, comprising:
a processor; and
a memory storing instructions that, when executed by the processor, cause the computer system to:
receive an order;
post a portion of the order to a merchandise board as a merchandise item;
generate a plurality of IOI shapes corresponding to the merchandise item;
map one or more clients to one or more tiers associated, each tier associated with one of the IOI shapes;
generate a client score for each of the one or more clients based on at least one of client financial data, client holdings, and historic client orders;
display clients and IOIs;
associate clients into one or more tiers with a corresponding IOI shape;
generate an IOI message for each IOI shape; and
transmit each IOI shape to each to the clients mapped to each corresponding tier.

2. The computer system of claim 1, further including determining if a reroll is necessary.

3. The computer system of claim 1, wherein each IOI shape corresponds to at least one of a price, a quantity, and a release time.

4. The computer system of claim 1, wherein the client financial data includes one or more of client trading activity, predetermined client preferences, currently held securities by the client, client exposure to various market sectors, and client or client competitor related news.

5. The computer system of claim 1, further including:
determining whether each of the one or more clients should be automatically opted-in based on the client score and other information; and
automatically opting-in clients based on the client score.

6. The computer system of claim 1, further including:
receiving instructions to override the opt-in of each client.

7. The computer system of claim 1, further including:
determining a time value for transmission of the IOI message.

8. A method for generating and distributing indications of interest (IOIs) to clients, comprising:
receiving an order;
posting a portion of the order to a merchandise board as a merchandise item;
generating a plurality of IOI shapes corresponding to the merchandise item;
mapping one or more clients to one or more tiers, each tier associated with one of the IOI shapes;
generating a client score for each of the one or more clients based on at least one of client financial data, client holdings, and historic client orders;
displaying clients and IOIs;
associating clients into one or more tiers with a corresponding IOI shape;
generating an IOI message for each IOI shape; and
transmitting each IOI shape to the clients mapped to each corresponding tier.

9. The method of claim 8, further comprising:
determining if a reroll is necessary.

10. The method of claim 8, wherein each IOI shape corresponds to at least one of a price, a quantity, and a release time.

11. The method of claim 8, wherein the client financial data includes one or more of client trading activity, predetermined client preferences, currently held securities by the client, client exposure to various market sectors, and client or client competitor related news.

12. The method of claim 8, further comprising:
determining whether each of the one or more clients should be automatically opted-in based on the client score and other information; and
automatically opting-in clients based on the client score.

13. The method of claim 8, further comprising:
receiving instructions to override the opt-in of each client.

14. The method of claim 8, further comprising:
determining a time value for transmission of the IOI message.

15. A non-transitory computer-readable medium storing instructions that, when executed by a processor, cause a computer system to generate and distribute indications of interest (IOIs) to clients, be performing the steps of:
receiving an order;
posting a portion of the order to a merchandise board as a merchandise item;
generating a plurality of IOI shapes corresponding to the merchandise item;
mapping one or more clients to one or more tiers, each tier associated with one of the IOI shapes;
generating a client score for each of the one or more clients based on at least one of client financial data, client holdings, and historic client orders;
displaying clients and IOIs;
associating clients into one or more tiers with a corresponding IOI shape;
generating an IOI message for each IOI shape; and
transmitting each IOI shape to the clients mapped to each corresponding tier.

16. The non-transitory computer-readable medium of claim 15, further including:
determining if a reroll is necessary.

17. The non-transitory computer-readable medium of claim 15, wherein each MI shape corresponds to at least one of a price, a quantity, and a release time.

18. The non-transitory computer-readable medium of claim 15, wherein the client financial data includes one or more of client trading activity, predetermined client preferences, currently held securities by the client, client exposure to various market sectors, and client or client competitor related news.

19. The non-transitory computer-readable medium of claim 15, further including:
determining whether each of the one or more clients should be automatically opted-in based on the client score and other information; and
automatically opting-in clients based on the client score.

20. The non-transitory computer-readable medium of claim 15, further including:
receiving instructions to override the opt-in of each client.

21. The non-transitory computer-readable medium of claim 15, further including:
determining a time value for transmission of the MI message.
